(19) United States
(12) Patent Application Publication
(10) Pub. No.: US 2013/0029864 A1
(43) Pub. Date: Jan. 31, 2013

(54) BIOMARKERS FOR ALZHEIMER'S DISEASE

(71) Applicants: Angelika Lueking, Bochum (DE); Stefan Müllner, Langenfeld (DE); Charlotte Teunissen, Amersfoort (NL); Jens Wiltfang, Essen (DE)

(72) Inventors: Angelika Lueking, Bochum (DE); Stefan Müllner, Langenfeld (DE); Charlotte Teunissen, Amersfoort (NL); Jens Wiltfang, Essen (DE)

(73) Assignee: PROTAGEN Aktiengesellschaft, Dortmund (DE)

(21) Appl. No.: 13/499,546

(22) PCT Filed: Oct. 1, 2010
(86) PCT No.: PCT/EP2010/064689

§ 371 Date: Oct. 17, 2012

(30) Foreign Application Priority Data
Oct. 1, 2009 (EP) 09171938.5

(51) Int. Cl. C40B 30/04; C40B 40/08

(52) U.S. Cl. 506/9; 506/17

(57) ABSTRACT

The invention relates to novel marker sequences for Alzheimer's disease, in particular Alzheimer's dementia, and their diagnostic use including a screening method in order to identify potential drugs for the treatment/prophylaxis of Alzheimer's disease by means of the said novel marker sequences. Moreover, the invention relates to a diagnostic device comprising said novel marker sequences for diagnosing Alzheimer's disease, particularly a protein array (chip) and its use hereto.

The invention relates to novel marker sequences for Alzheimer's disease, in particular Alzheimer's dementia, and their diagnostic use including a screening method in order to identify potential drugs for the treatment/prophylaxis of Alzheimer's disease by means of the said novel marker sequences. Moreover, the invention relates to a diagnostic device comprising said novel marker sequences for diagnosing Alzheimer's disease, particularly a protein array (chip) and its use hereto.

Protein biochips are of increasing industrial importance regarding analysis and diagnostics, as well as for pharmaceutical development.

Particularly, a high gain of information could be provided using protein biochips in the analysis of the genome and of gene expression. Hereby, the fast and highly parallel detection of a multiplicity of specifically binding analysis molecules in the course of a single experiment is enabled. To generate protein biochips it is necessary that the required proteins are available. For this purpose, protein expression libraries were established. One possibility is high-throughput cloning of defined open reading frames (Heyman, J. A., Cornthwaite, J., Foncerrada, L., Gilmore, J. R., Gontang, E., Hartman, K. J., Hernandez, C. L., Hood, R., Hull, H. M., Lee, W. Y., Marcil, R., Marsh, E. J., Mudd, K. M., Patino, M. J., Purcell, T. J., Rowland, J. J., Sindici, M. L. and Hoeffler, J. P. (1999) Genome-scale cloning and expression of individual open reading frames using topoisomerase I-mediated ligation. Genome Res, 9, 383-392; Kersten, B., Feilner, T., Kramer, A., Wehrmeyer, S., Possling, A., Witt, I., Zanor, M. I., Stracke, R., Lueking, A., Kreutzberger, J., Lehrach, H. and Cahill, D. J. (2003) Generation of Arabidopsis protein chip for antibody and serum screening. Plant Molecular Biology, 52, 999-1010; Reboul, J., Vaglio, P., Rual, J. F., Lamesch, P., Martinez, M., Armstrong, C. M., Li, S., Jacotot, L., Bertin, N., Janky, R., Moore, T., Hudson, J. R., Jr., Hartley, J. L., Brasch, M. A., Vandenhaute, J., Boulton, S., Endress, G. A., Jenna, S., Chevet, E., Papasotiropoulos, V., Tolias, P. P., Ptacek, J., Snyder, M., Huang, R., Chance, M. R., Lee, H., Doucette-Stamm, L., Hill, D. E. and Vidal, M. (2003) C. elegans ORFeome version 1.1: experimental verification of the genome annotation and resource for proteome-scale protein expression. Nat Genet, 34, 35-41; Walhout, A. J., Temple, G. F., Brasch, M. A., Hartley, J. L., Lorson, M. A., van den Heuvel, S, and Vidal, M. (2000) GATEWAY recombinational cloning: application to the cloning of large numbers of open reading frames or ORFeomes. Methods Enzymol, 328, 575-592). However, this approach highly depends on the progress of genome sequencing projects and the annotation of these gene sequences. Furthermore, the determination of the expressed sequence can be ambiguous due to differential splicing processes. This problem may be circumvented by application of cDNA expression libraries (Büssow, K., Cahill, D., Nietfeld, W., Bancroft, D., Scherzinger, E., Lehrach, H. and Walter, G. (1998) A method for global protein expression and antibody screening on high-density filters of an arrayed cDNA library. Nucleic Acids Research, 26, 5007-5008; Büssow, K., Nordhoff, E., Lübbert, C., Lehrach, H. and Walter, G. (2000) A human cDNA library for high-throughput protein expression screening. Genomics, 65, 1-8; Holz, C., Lueking, A., Bovekamp, L., Gutjahr, C., Bolotina, N., Lehrach, H. and Cahill, D. J. (2001) A human cDNA expression library in yeast enriched for open reading frames. Genome Res, 11, 1730-1735; Lueking, A., Holz, C., Gotthold, C., Lehrach, H. and Cahill, D. (2000) A system for dual protein expression in Pichia pastoris and Escherichia coli, Protein Expr. Purif., 20, 372-378). Hereby, the cDNA of a particular tissue is cloned into a bacterial or a yeast expression vector. The vectors used for the expression are characterized in general by carrying inducible promoters that may be used to control the time of protein expression. Furthermore, expression vectors comprise sequences for so-called affinity epitopes or proteins which permit the specific detection of recombinant fusion proteins using an antibody directed against the affinity epitope, as well as the specific purification through affinity chromatography (IMAC).

For example, the gene products of a cDNA expression library from human fetal brain tissue in the bacterial expression system Escherichia coli were arranged in a high-density format on a membrane, and could be screened successfully with various antibodies. It could be shown that there were at least 66% full length proteins. Additionally, the recombinant proteins of this library could be expressed and purified in high-throughput manner (Braun P., Hu, Y., Shen, B., Halleck, A., Koundinya, M., Harlow, E. and LaBaer, J. (2002) Proteome-scale purification of human proteins from bacteria. Proc Natl Acad Sci USA, 99, 2654-2659; Büssow (2000) supra; Lueking, A., Horn, M., Eickhoff, H., Büssow, K., Lehrach, H. and Walter, G. (1999) Protein microarrays for gene expression and antibody screening. Analytical Biochemistry, 270, 103-111). Particularly, such protein biochips based on cDNA expression libraries are a subject of WO 99/57311 and WO 99/57312.

Recently, protein arrays and protein biochips have been used as well. For example, the binding specificity of various monoclonal antibodies such as anti HSP90, anti GAPDH or anti a-tubulin, could be analyzed in individual experiments on a protein microarray consisting of 96 human recombinantly expressed proteins (Lueking (1999) supra). Also, cross-reactivity of two monoclonal antibodies against approximately 2,500 different proteins could be studied (Lueking, A., Possling, A., Huber, 0., Beveridge, A., Horn, M., Eickhoff, H., Schuchardt, J., Lehrach, H. and Cahill, D. J. (2003) A Nonredundant Human Protein Chip for Antibody Screening and Serum Profiling. Mol Cell Proteomics, 2, 1342-1349). Other protein biochips are described in e.g. Lal et al or Kusnezow et al. (Lal et al (2002) Antibody arrays: An embryonic but rapidly growing technology, DDT, 7, 143-149; Kusnezow et al. (2003), Antibody microarrays: An evaluation of production parameters, Proteomics, 3, 254-264).

Protein biochips have an advantageously high sensitivity.

Proceeding from the described prior art, the object therefore presents itself of providing a protein biochip, specifically directed to the diagnosis of Alzheimer's disease, in particular Alzheimer's dementia.

There exists however a great need to come up with a reliable diagnosis in order to provide novel improved marker sequences and their diagnostic use for the treatment of Alzheimer's disease, in particular Alzheimer's dementia.

Thus, the technical problem underlying the invention is to provide improved (bio)markers and their diagnostic use for the treatment and prophylaxis of Alzheimer's disease, in particular Alzheimer's dementia.

The object is achieved according to the invention by providing the SEQ 1-179 of novel marker sequences, firstly identified by means of a protein biochip along with bioinformatics.

A further disadvantage is that in the prior art, sufficient sensitivity and/or specificity of the markers is/are usually not achieved.

On the one hand, the object is solved by providing the diagnostic markers of at least one cDNA selected from the group of SEQ 1-179 or each encoding a peptide thereof, or a partial sequence or fragment thereof, for diagnosing Alzheimer's disease, in particular Alzheimer's dementia, on the other hand, by means of a method for in-vitro diagnosing and/or stratifying the risk of Alzheimer's disease, in particular Alzheimer's dementia. In said method, at least one cDNA is selected from the group of SEQ 1-179 or each encoding a peptide thereof, or a partial sequence or fragment thereof, is/are determined in or from a patient who is to be examined (below method according to the invention).

The marker sequences according to the invention can be identified by differential screening of samples of healthy patients in comparison with patients suffering from Alzheimer's disease, in particular Alzheimer's dementia.

According to the invention, the term “risk stratification” encompasses the identification of patients, in particular emergency care and at-risk patients, with an unfavorable prognosis, for intensive diagnostics and for therapy/treatment/prophylaxis of Alzheimer's disease, in particular Alzheimer's dementia with the objective of enabling an optimal clinical outcome. Risk stratification according to the invention thus allows effective treatment methods for Alzheimer's disease, in particular Alzheimer's dementia and the newest medicaments.

A reliable diagnosis can take place by means of the method according to the invention, in particularly advantageous manner, and especially in cases of intensive care medicine. The method according to the invention allows clinical decisions that lead to rapid therapy success. Such clinical decisions also comprise further therapy by means of medications for treatment or therapy of Alzheimer's disease, in particular Alzheimer's dementia.

The invention therefore further relates to the identification of patients with increased risk and/or unfavorable prognosis of Alzheimer's disease, in particular Alzheimer's dementia, and symptomatic and/or asymptomatic patients.

Hence, the present invention is directed to a method for risk stratification for Alzheimer's disease, in particular Alzheimer's dementia, wherein at least one cDNA is selected from the group of SEQ 1-179 (SEQ 1a-179a) or each encoding a peptide thereof, or a partial sequence or fragment thereof, is determined by an in vitro diagnosis, preferably with the use of a protein biochip.

In the context of this invention, the term “Alzheimer's disease, in particular Alzheimer's dementia” can be understood as defined on the terms of Pschyrembel, Klinisches Wörterbuch [Clinical Dictionary], 261th edition, 2007, Berlin, for example.

In a preferred embodiment of the invention at least 2 to 5 or 10, preferably 30 to 50 marker sequences or 50 to 100 or more marker sequences are determined in or from a patient who is to be examined.

The marker sequences in accordance with the invention encompass the partial sequences or fragments thereof. In particular, such partial sequences preferably comprise 60% of the sequence of a (bio)marker according to the invention, in particular 70% and more, 80% and more, in particular 90 to 95% and fragments may have a sequence length of e.g. 50-100 or 70-120 nucleotides or encoding peptide of the said marker sequences.

In a further preferred embodiment of the invention the marker sequences according to the invention can be combined with other known biomarkers of the Alzheimer's disease, in particular Alzheimer's dementia.

In an embodiment of the method according to the invention, bodily fluid or tissue, particularly blood or most preferably cerebrospinal fluid (CSF), is taken from the patient to be examined, optionally whole blood or serum or obtainable plasma, and the diagnosis takes place in vitro/ex vivo, i.e. outside of the human or animal body.

It is very preferred that the probe is taken from cerebrospinal fluid (CSF) of the patient to be examined.

In a further preferred embodiment of the invention the invention relates to the use of the marker sequences as diagnostics, wherein at least one cDNA is selected from the group of SEQ 1-179 (SEQ 1a-179a) or each encoding a peptide thereof, or a partial sequence or fragment thereof.

The marker sequences according to the invention are subject of Table A along with the identified data base entry (cf. http://www.ncbi.nlm.nih.gov/) in order to point the known function of the marker sequences.

However, the said identified marker sequences do not refer to the full length sequences as depicted in the data base, but do refer to a part/fragment of said sequences, hereinafter SEQ 1-179.

In a further preferred embodiment the invention relates also to the full length sequences SEQ 1a-179a as identified in Table 1.

In a further embodiment the present invention is directed to a method for diagnosing Alzheimer's disease, in particular Alzheimer's dementia, wherein

a.) at least one cDNA selected from the group of SEQ 1-179 (SEQ 1a-179a) or each encoding a peptide thereof, or a partial sequence or fragment thereof is/are fixed on a solid support,
b.) contacting with a bodily fluid of a patient,
c.) determining/detecting a binding event between the bodily fluid and the marker sequence(s).

The determination of a binding event can be carried out with an antibody, probe or the like. The detection of the proteins used as the marker sequences may also be performed with the aid of further protein diagnostic methods known to those skilled in the art, in particular employing radioactive or fluorescence-marked antibodies. In particular, bioanalytical methods suitable for this purpose are to be cited here, such as immunohistochemistry, antibody arrays, luminex, ELISA, immunofluorescence, and radio immunoassays.

The term “solid support” comprises designs such as a filter, a membrane, a magnetic bead, a silica wafer, glass, metal, ceramics, plastics, a chip, a target for mass spectrometry or a matrix.

Said solid support may be chemically coated. For this, silylation, polylysine, epoxydation or other common coatings known to the skilled person may be especially considered.

As a filter, PVDF or nylon are preferred (e.g. Hybond N+ Amersham), whereas nitrocellulose (e.g. Schleicher & Schuell) is especially preferred. Said filter is preferably mounted on a second solid support which is preferably selected from silica wafer, glass, metal, plastics or ceramics.

Furthermore it is preferred that the solid support is planar and flat.

In another preferred embodiment of the array according to the invention, the array corresponds to a grid with the dimensions of a microtiter plate (96 wells, 384 wells or more), a silica wafer, a chip, a target for mass spectrometry, or a matrix. According to the invention, such an array according to the invention may enable screening of at least one binder to the protein binders with subsequent interpretation. After the binder has contacted a marker sequence, interpretation is conducted, for example using commercially available image analyzing software (GenePix Pro (Axon Laboratories), Aida (Ray test), ScanArray (Packard Bioscience).

The term “marker sequences” according to the invention means that a cDNA or an encoded peptide or protein is significant for Alzheimer's disease, in particular Alzheimer's dementia. For example, cDNA or each encoded peptide or protein thereof may have an interaction with substances of bodily fluids or tissue of a patient suffering from Alzheimer's disease, in particular Alzheimer's dementia (e.g. (Auto)Antigens (Epitop)/(Auto)Antibodies (Paratop) interaction). Such an interaction may be a binding between the interaction partners, like a hybridization in case of a cDNA or a peptide-peptide interaction or a mixture thereof (cf. e.g. J. Sambrook, E. F. Fritsch, T. Maniatis (1989), Molecular cloning: A laboratory manual, 2nd Edition, Cold Spring Harbor Laboratory Press, Cold Spring Harbor, USA oder Ausubel, “Current Protocols in Molecular Biology”, Green Publishing Associates and Wiley Interscience, N.Y. (1989)).

These marker sequences according to the invention may also have post-translational modifications in case of peptides such as glycolization, lip(o)idization, or derivatization.

In a particular embodiment, the marker sequences are present as clones. For example, such clones may be obtained by using a cDNA expression library according to the invention (Büssow et al. 1998 (supra)). In a preferred embodiment, such expression libraries containing clones are obtained using expression vectors from a cDNA expression library. These expression vectors preferably contain inducible promoters. Induction of the expression may be obtained e.g. using an inductor such as IPTG. Suitable expressions vectors are described in Terpe et al. (Terpe T. Appl Microbiol Biotechnol. 2003 January; 60(5):523-33). Additionally, the expression product is present preferably in the form of a fusion protein which contains for example at least one affinity epitope or tag. The tag may be one, but not limited to, containing c-myc, his tag, arg tag, FLAG, alkaline phosphatase, VS tag, T7 tag or strep tag, HAT tag, NusA, S tag, SBP tag, thioredoxin, DsbA, a fusion protein, preferably a cellulose-binding domain, green fluorescent protein, maltose-binding protein, calmodulin-binding protein, glutathione S-transferase or lacZ.

Expression libraries are known to a skilled person in the art; they may be prepared according to standard text books such as Sambrook et al, “Molecular Cloning, A laboratory handbook, 2nd edition (1989), CSH press, Cold Spring Harbor, N.Y. Also preferred are tissue-specific expression libraries (e.g. human tissue, especially human organs). Furthermore included according to the invention are expression libraries that can be obtained by exon-trapping. A synonym for expression library is expression bank.

Also preferred are protein biochips or corresponding expression libraries that do not exhibit any redundancy (so called: Uniclone® library) and that may be prepared for example according to the teachings of WO 99/57311 and WO 99/57312. These preferred Uniclone libraries have a high portion of non-defective fully expressed proteins of a cDNA expression library.

Within the context of this invention, the clones could also be, but not limited to, transformed bacteria, recombinant phages or transformed cells from mammals, insects, fungi, yeast or plants.

Hence, the present invention relates to an array, a diagnostic device or an arrangement of marker sequences or a in particular protein biochip for diagnosing Alzheimer's disease, in particular Alzheimer's dementia comprising at least one cDNA selected from the group of SEQ 1-179 (SEQ 1a-179a) or each encoding a peptide thereof, or a partial sequence or fragment thereof is/are fixed on a solid support.

The purpose of the following examples and figures is to explain the invention in greater detail, without however limiting the invention to said examples and figures.

### EXAMPLES

A protein biochip printed with >2700 autoantigen candidates was used to determine the IgG autoantibody repertoire in CSF (cerebrospinal fluid) samples of patients. CSF from patients with Alzheimer's Disease (AD) and controls were analyzed. Despite the small sample set, putative autoantigen candidates recognized by IgG in CSF from patients with AD have been identified using a threshold algorithm. Some of the putative autoantigens such as carbohydrate sulfotransferase-7 (CHST7), alpha 2 glycoprotein 1 (AZGP1), histone deacetylases (5 and 3), zinc finger and SCAN domain containing 21 (ZSCAN21), hairy and enhancer of split 5 (Drosophila) (HES5) and hippocalcin already described in the literature with regards to neurodegenerative and developmental diseases. This suggests that CSF is a highly suitable and preferred body fluid enabling diagnostic and prognostic purposes.

### Samples

Before the samples were incubated on Protein-Biochips, all samples were filtered with Sartorius VIVASPIN 2 columns (Product-Nr. VS0201) with a 10,000 MWCO PES membrane to separate peptides from the protein solution. During this filtration samples supplied in more than one tube were pooled. The supernatant of each sample was collected and used for the incubation on Protein-Biochips.

### Protein Biochip and Layout

The protein biochip contains more than 2700 affinity purified autoantigen candidates and is suitable for identification of human proteins detected by antibodies in biological samples. The expressed proteins are derived from different proprietary UNIclone® expression libraries and represent multiple gene families including pharmaceutically relevant protein classes such as kinases, membrane-associated proteins, cell-signalling proteins and metabolic proteins. All clones have been verified by DNA sequencing. Each human open reading frame (ORF) is expressed as an N-terminal His-tag fusion protein in Escherichia coli followed by immobilized metal ion affinity chromatography (IMAC) purification. The protein biochip consists of two fields each consisting of 16 subarrays. The two fields contain more than 2700 recombinant human proteins, which are printed in duplicates.

In addition, each subarray contains printed serial dilutions of control proteins, e.g. human or mouse immunoglobulin. The quality of the spotting and hybridization process is monitored for each chip by calculating the coefficient of variation (CV) of the control proteins.

### Incubation of Protein Biochips

The protein biochips were blocked for 1 h and incubated with the samples for 16 h at room temperature. The CSF samples were diluted 1:5 in incubation buffer. The partner supplied control samples were used as a reference.

The over-night incubation maximizes both antibody binding and refolding of immobilized proteins to reconstitute structural epitopes. Then, the microarrays were washed three times in washing buffer, and subsequently incubated with the antibody cascade in incubation buffer for 1 h at room temperature, followed by three washes with washing buffer. All incubation steps were carried out in a volume of 200 μl in an automated, temperature-controlled hybridization station (Tecan HS 4800 Pro). Read out of the results was performed with a confocal microarray reader (ScanArray 4000, Perkin Elmer Life Science) using identical settings for all biochips.

### Image and Data Analysis

Image analysis was performed using the software package GenePix Pro 6.0 (Molecular Devices). The mean intensity (median background subtracted) was determined for each protein spot. For bioinformatic analysis the average intensity of the two protein spots of each protein is determined which is then normalized using a concentration from the IgG process controls which has a medium signal intensity (signal antigen/mean signal of IgG process control×100=X units).

### Bioinformatic Analysis

To assess the classification potential of the data the following classification strategy was used to calculate important statistical measures such as sensitivity and specificity:

1. For each protein the mean intensity and standard deviation in the group of controls is calculated.
2. For each protein a cut-off level is defined, which is equal to the mean intensity plus 2 standard deviations.
3. For each protein the number of samples is counted that are above this threshold in the patient as well as the control group. Samples above this threshold are called “positive” and coloured blue in the final graphical representation.

The bioinformatics including determination of individual protein threshold is carried out by means of several tests.

In a first approach a Bonferroni Correction is carried out and thereafter a False Discovery Rate (FDR) is calculated in accordance with Benjamini & Hochberg. Moreover the rating of the proteins is supported by Support Vector Machines (SVM) (statistical approach).

### Significance Ranking of Marker Candidates

The CSF samples were incubated on protein biochips containing 2700 human proteins resulting in Table A (representing SEQ 1a-179a) and the enclosed sequence listing (SEQ 1-179).

TABLE A

| | |
|---|---|
| gi\|13128861 | Homo sapiens histone deacetylase 3 (HDAC3). mRNA |
| gi\|63252907 | Homo sapiens IQ motif and WD repeats 1 (IQWD1) transcript |
| | variant 1 mRNA |
| gi\|90903236 | Homo sapiens glutathione peroxidase 4 (phospholipid |
| | hydroperoxidase) (GPX4) transcript variant 1 mRNA |
| gi\|50086623 | Homo sapiens integrator complex subunit 4 (INTS4). mRNA |
| gi\|38679885 | Homo sapiens splA/ryanodine receptor domain and SOCS box |
| | containing 3 (SPSB3) mRNA |
| gi\|12408641 | Homo sapiens bromodomain containing 2 (BRD2). mRNA |
| gi\|4826881 | Homo sapiens THO complex 1 (THOC1). mRNA |
| gi\|37550270 | Homo sapiens chromosome 5 genomic contig. reference assembly |
| gi\|6005923 | Homo sapiens family with sequence similarity 107. member A |
| | (FAM107A). mRNA |
| gi\|89029256 | Homo sapiens chromosome 9 genomic contig. reference assembly |
| gi\|58219047 | Homo sapiens hairy and enhancer of split 5 (Drosophila) (HES5). |
| | mRNA |
| gi\|55925607 | Homo sapiens kelch-like 21 (Drosophila) (KLHL21) mRNA |
| gi\|33469963 | Homo sapiens splicing factor 4 (SF4) mRNA |
| gi\|38372939 | Homo sapiens alpha-2-glycoprotein 1 zinc (AZGP1) mRNA |
| gi\|13325056 | Homo sapiens solute carrier family 27 (fatty acid transporter) |
| | member 5 (SLC27A5) mRNA |
| gi\|51474120 | Homo sapiens chromosome 17 genomic contig reference assembly |
| gi\|63497678 | Homo sapiens chromosome 1 open reading frame 131 (C1orf131) |
| | mRNA |
| gi\|89035772 | Homo sapiens chromosome 12 genomic contig. reference assembly |
| gi\|4557440 | Homo sapiens cyclin-dependent kinase inhibitor 1C (p57. Kip2) |
| | (CDKN1C). mRNA |
| gi\|30581146 | Homo sapiens proteasome (prosome. macropain) inhibitor subunit 1 |
| | (PI31) (PSMF1). transcript variant 1. mRNA |
| gi\|22035555 | Homo sapiens BRF1 homolog subunit of RNA polymerase III |
| | transcription initiation factor IIIB (S. cerevisiae) (BRF1) transcript |
| | variant 1 mRNA |
| gi\|71164877 | Homo sapiens ribosomal protein S12 (RPS12) mRNA |
| gi\|18390348 | Homo sapiens ribosomal protein L7a (RPL7A) mRNA |
| gi\|51317357 | Homo sapiens HGFL gene (MGC17330). mRNA |
| gi\|10518498 | Homo sapiens ring finger protein 24 (RNF24). mRNA |
| gi\|8051607 | Homo sapiens heme oxygenase (decycling) 2 (HMOX2) mRNA |
| gi\|4758272 | endosulfine alpha isoform 3 [Homo sapiens] |
| gi\|50878292 | Homo sapiens tripartite motif-containing 45 (TRIM45) mRNA |
| gi\|4758985 | Homo sapiens RAB11B member RAS oncogene family (RAB11B) |
| | mRNA |
| gi\|16905511 | Homo sapiens ribosomal protein large P1 (RPLP1) transcript variant |
| | 1 mRNA |
| gi\|23510452 | Homo sapiens coactosin-like 1 (Dictyostelium) (COTL1). mRNA |
| gi\|50345985 | Homo sapiens ATP synthase. H+ transporting. mitochondrial F1 |
| | complex. beta polypeptide (ATP5B). nuclear gene encoding |
| | mitochondrial protein. mRNA |
| gi\|42794610 | Homo sapiens 6-phosphogluconolactonase (PGLS). mRNA |
| gi\|7669552 | Homo sapiens valosin-containing protein (VCP) mRNA |
| gi\|33286445 | Homo sapiens opioid growth factor receptor (OGFR) mRNA |
| gi\|16550193 | unnamed protein product [Homo sapiens] |
| gi\|39725676 | Homo sapiens nucleobindin 1 (NUCB1). mRNA |
| gi\|40353201 | Homo sapiens OTU domain containing 5 (OTUD5). mRNA |
| gi\|28178831 | Homo sapiens isocitrate dehydrogenase 2 (NADP+). mitochondrial |
| | (IDH2). mRNA |
| gi\|37537685 | Homo sapiens zinc finger and SCAN domain containing 21 |
| | (ZSCAN21). mRNA |
| gi\|20149616 | Homo sapiens neural proliferation differentiation and control 1 |
| | (NPDC1) mRNA |
| gi\|57242773 | Homo sapiens KIAA0100 (KIAA0100). mRNA |
| gi\|32171243 | Homo sapiens hypothetical protein DKFZp434G156 (NAG6) mRNA |
| gi\|49640010 | Homo sapiens tetratricopeptide repeat domain 3 (TTC3). transcript |
| | variant 2. mRNA |
| gi\|23238227 | Homo sapiens carbohydrate (N-acetylglucosamine 6-O) |
| | sulfotransferase 7 (CHST7) mRNA |
| gi\|19743568 | Homo sapiens TRAF family member-associated NFKB activator |
| | (TANK). transcript variant 1. mRNA |
| gi\|15214427 | PRG2 protein [Homo sapiens] |
| gi\|46358416 | Homo sapiens glutamate receptor metabotropic 3 (GRM3) mRNA |
| gi\|5031931 | nascent-polypeptide-associated complex alpha polypeptide [Homo |
| | sapiens] |
| gi\|45439358 | Homo sapiens triple functional domain (PTPRF interacting) (TRIO). |
| | mRNA |
| gi\|4324699 | nuclear mitotic apparatus protein 1 [Homo sapiens] |
| gi\|72534683 | Homo sapiens phospholipase D family. member 3 (PLD3). |
| | transcript variant 1. mRNA |
| gi\|67906194 | Homo sapiens ankyrin repeat and sterile alpha motif domain |
| | containing 6 (ANKS6) mRNA |
| gi\|7705806 | Homo sapiens coenzyme Q4 homolog (S. cerevisiae) (COQ4). |
| | mRNA |
| gi\|40353728 | Homo sapiens Ras and Rab interactor 3 (RIN3). mRNA |
| gi\|88942921 | Homo sapiens chromosome 1 genomic contig. reference assembly |
| gi\|113430465 | PREDICTED: Homo sapiens similar to ataxin 7-like 3 (LOC392485) |
| | mRNA |
| gi\|7705480 | Homo sapiens ubiquitin-fold modifier conjugating enzyme 1 (UFC1). |
| | mRNA |
| gi\|62750346 | Homo sapiens histone deacetylase 5 (HDAC5). transcript variant 1. |
| | mRNA |
| gi\|68800242 | Homo sapiens interleukin-1 receptor-associated kinase 1 (IRAK1). |
| | transcript variant 1. mRNA |
| gi\|71361681 | Homo sapiens nuclear mitotic apparatus protein 1 (NUMA1) mRNA |
| gi\|89040669 | Homo sapiens chromosome 16 genomic contig. alternate assembly |
| | (based on Celera assembly) |
| gi\|61102726 | Homo sapiens La ribonucleoprotein domain family member 1 |
| | (LARP1) transcript variant 1 mRNA |
| gi\|14249519 | Homo sapiens hypothetical protein FLJ14668 (FLJ14668) mRNA |
| gi\|89057698 | Homo sapiens chromosome 19 genomic contig alternate assembly |
| | (based on Celera assembly) |
| gi\|14110406 | Homo sapiens heterogeneous nuclear ribonucleoprotein D-like |
| | (HNRPDL) transcript variant 2 mRNA |
| gi\|5032030 | Homo sapiens RNA binding motif protein 5 (RBM5) mRNA |
| gi\|92859637 | Homo sapiens synaptotagmin V (SYT5) mRNA |
| gi\|33469975 | Homo sapiens activating transcription factor 4 (tax-responsive |
| | enhancer element B67) (ATF4) transcript variant 1 mRNA |
| gi\|17149845 | Homo sapiens FK506 binding protein 3. 25 kDa (FKBP3). mRNA |
| gi\|39573729 | Homo sapiens family with sequence similarity 39. member B |
| | (FAM39B). mRNA |
| gi\|56682958 | Homo sapiens ferritin. heavy polypeptide 1 (FTH1). mRNA |
| gi\|31652250 | Homo sapiens chromosome 3 open reading frame 19 (C3orf19). |
| | mRNA |
| gi\|22748978 | Homo sapiens chromosome 17 open reading frame 32 (C17orf32) |
| | mRNA |
| gi\|14110410 | Homo sapiens heterogeneous nuclear ribonucleoprotein D-like |
| | (HNRPDL) transcript variant 1 mRNA |
| gi\|4503528 | Homo sapiens eukaryotic translation initiation factor 4A isoform 1 |
| | (EIF4A1) mRNA |
| gi\|34147700 | Homo sapiens dehydrogenase/reductase (SDR family) member 13 |
| | (DHRS13) mRNA |
| gi\|113402448 | PREDICTED: Homo sapiens similar to CXYorf1-related protein |
| | (LOC653635) mRNA |
| gi\|8922357 | Homo sapiens PRP38 pre-mRNA processing factor 38 (yeast) |
| | domain containing B (PRPF38B) mRNA |
| gi\|32880228 | Homo sapiens selenoprotein O (SELO) mRNA |
| gi\|89033689 | Homo sapiens chromosome 10 genomic contig alternate assembly |
| | (based on Celera assembly) |
| gi\|71772259 | Homo sapiens ribosomal protein L5 (RPL5) mRNA |
| gi\|5174742 | Homo sapiens ubiquinol-cytochrome c reductase. Rieske iron-sulfur |
| | polypeptide 1 (UQCRFS1). mRNA |
| gi\|68448524 | Homo sapiens CD74 molecule major histocompatibility complex |
| | class II invariant chain (CD74) transcript variant 2 mRNA |
| gi\|47078280 | Homo sapiens family with sequence similarity 53 member B |
| | (FAM53B) mRNA |
| gi\|46389548 | Homo sapiens endosulfine alpha (ENSA). transcript variant 3. |
| | mRNA |
| gi\|16507207 | Homo sapiens capicua homolog (Drosophila) (CIC) mRNA |
| gi\|74027246 | Homo sapiens polyglutamine binding protein 1 (PQBP1) transcript |
| | variant 2 mRNA |
| gi\|113421166 | PREDICTED: Homo sapiens ankyrin repeat and sterile alpha motif |
| | domain containing 6 (ANKS6). mRNA |
| gi\|32484989 | Homo sapiens WD repeat and SOCS box-containing 2 (WSB2) |
| | mRNA |
| gi\|70673344 | Hexaribonucleotide binding protein 3 [Homo sapiens] |
| gi\|39725675 | Homo sapiens CDK2-associated protein 2 (CDK2AP2). mRNA |
| gi\|46411160 | Homo sapiens aconitase 2. mitochondrial (ACO2). nuclear gene |
| | encoding mitochondrial protein. mRNA |
| gi\|45439300 | Homo sapiens zinc finger protein 238 (ZNF238). transcript variant 2. |
| | mRNA |
| gi\|51468814 | Homo sapiens chromosome 11 genomic contig. reference assembly |
| gi\|74048536 | Homo sapiens praja 1 (PJA1) transcript variant 2 mRNA |
| gi\|73622128 | Homo sapiens caspase 6. apoptosis-related cysteine peptidase |
| | (CASP6). transcript variant alpha. mRNA |
| gi\|56181386 | Homo sapiens STIP1 homology and U-box containing protein 1 |
| | (STUB1) mRNA |
| NM_003333 | Homo sapiens ubiquitin A-52 residue ribosomal protein fusion |
| | product 1 (UBA52). transcript variant 2. mRNA |
| gi\|34147350 | Homo sapiens RAS-like family 11 member B (RASL11B) mRNA |
| gi\|34098945 | Homo sapiens Y box binding protein 1 (YBX1). mRNA |
| gi\|29826322 | Homo sapiens adducin 1 (alpha) (ADD1) transcript variant 3 mRNA |
| NT_010194 | Homo sapiens chromosome 15 genomic contig. reference assembly |
| gi\|8923114 | OTU domain-ubiquitin aldehyde binding 1 [Homo sapiens] |
| gi\|7020770 | unnamed protein product [Homo sapiens] |
| gi\|50820 | unnamed protein product [Mus musculus] |
| gi\|30583065 | asparagine synthetase [Homo sapiens] |
| gi\|50513864 | A Chain A-Structure-Activity Relationships In Purine-Based |
| | Inhibitor Binding To Hsp90 Isoforms |
| gi\|30048193 | PMF1 protein [Homo sapiens] |
| gi\|4885065 | amyloid precursor-like protein 1 isoform 2 precursor [Homo sapiens] |
| gi\|1177230 | zinc finger-Method: conceptual translation supplied by author |
| | [Homo sapiens] |
| gi\|14603190 | Melanoma antigen-family F-1 |
| gi\|603953 | KIAA0082 [Homo sapiens] |
| gi\|33150668 | rab1B ** |
| gi\|11056030 | protocadherin gamma subfamily A-2 isoform 1 precursor |
| gi\|30583897 | Homo sapiens ret finger protein * |
| gi\|39644771 | HNRPDL protein [Homo sapiens] |
| gi\|34533842 | unnamed protein product [Homo sapiens] |
| gi\|7512821 | T00347 hypothetical protein DKFZp566G1246.1-version I-human |
| | (fragment) |
| gi\|38197056 | FAM65A protein [Homo sapiens] |
| gi\|6679189 | P24B [Homo sapiens] |
| gi\|5453617 | zinc finger-HIT domain containing 1-putative cyclin G1 interacting |
| | protein-H_DJ0747G18.14-zinc finger protein-subfamily 4A (HIT |
| | domain containing)-member 1 |
| gi\|13559175 | dJ423B22.4 (ribosomal protein S27 (metallopanstimulin 1)) |
| gi\|30583223 | signal sequence receptor-delta (translocon-associated protein |
| | delta) [Homo sapiens] |
| gi\|10835234 | RED protein [Homo sapiens] |
| gi\|10720282 | Sorting nexin 4 [Homo sapiens] |
| gi\|7765076 | S3 ribosomal protein [Homo sapiens] |
| gi\|40786791 | complement component 3 [Homo sapiens] |
| gi\|34875599 | similar to chromosome 17 open reading frame 27 [Rattus |
| | norvegicus] |
| gi\|37547297 | hairy and enhancer of split 5 (Drosophila) [Homo sapiens] |
| gi\|37182091 | YME1L1 [Homo sapiens] |
| gi\|1477787 | suppressor of hairless protein 2 [Xenopus laevis] |
| gi\|4929268 | LOMP protein [Homo sapiens] |
| gi\|31747344 | ribosomal protein [Bothrops jararacussu] |
| gi\|1346343 | Keratin-type II cytoskeletal 1 (Cytokeratin 1) (K1) (CK 1) (67 kDa |
| | cytokeratin) (Hair alpha protein) |
| gi\|551450 | splicing factor SF3a60 [Homo sapiens] |
| gi\|15010818 | JKTBP1delta6 [Homo sapiens] |
| gi\|14705264 | HMGB2 protein [Homo sapiens] |
| gi\|31873909 | hypothetical protein [Homo sapiens] |
| gi\|21328448 | tyrosine 3-monooxygenase/tryptophan 5-monooxygenase activation |
| | protein-beta polypeptide [Homo sapiens] |
| gi\|42490994 | Unknown (protein for MGC: 87455) [Homo sapiens] |
| gi\|7657514 | GTP-binding protein RHO6 [Homo sapiens] |
| gi\|7705475 | hypothetical protein HSPC148 [Homo sapiens] |
| gi\|13358928 | hypothetical protein [Macaca fascicularis] |
| gi\|6063691 | porin isoform 1 [Homo sapiens] |
| gi\|2911264 | Unknown gene product [Homo sapiens] |
| gi\|28279301 | SYT5 protein [Homo sapiens] |
| gi\|22137761 | Phospholipase C-like 2 |
| gi\|19913512 | Fusion (involved in t(12-16) in malignant liposarcoma) |
| | [Homo sapiens] |
| gi\|37577151 | aortic preferentially expressed gene 1 [Homo sapiens] |
| gi\|30584105 | Homo sapiens mevalonate (diphospho) decarboxylase [synthetic |
| | construct] |
| gi\|34533094 | unnamed protein product [Homo sapiens] |
| gi\|11041473 | hypothetical protein [Macaca fascicularis] |
| gi\|49868 | put. beta-actin (aa 27-375) [Mus musculus] |
| gi\|4501841 | alanyl-tRNA synthetase [Homo sapiens] |
| gi\|32425497 | RAN protein [Homo sapiens] |
| gi\|38492965 | Chain A-Ef-Tu.Kirromycin Coordinates Fitted Into The Cryo-Em |
| | Map Of Ef-Tu Ternary Complex (Gdp.Kirromycin) Bound 70s |
| | Ribosome |
| gi\|42734381 | hypothetical protein BC009514 [Homo sapiens] |
| gi\|5730023 | RuvB-like 2 [Homo sapiens] |
| gi\|18606060 | Unknown (protein for IMAGE: 3538792) [Homo sapiens] |
| gi\|22760734 | unnamed protein product [Homo sapiens] |
| gi\|18088244 | PAI-RBP1 protein [Homo sapiens] |
| gi\|34782919 | FMNL1 protein [Homo sapiens] |
| gi\|22035554 | amyloid beta A4 precursor protein-binding-family B-member 1 |
| | isoform delta E9 [Homo sapiens] |
| gi\|7020622 | unnamed protein product [Homo sapiens] |
| gi\|7262378 | FGF intracellular binding protein isoform b 28 kDa |
| gi\|30582607 | Rho GDP dissociation inhibitor (GDI) alpha |
| gi\|14548073 | IKBE_HUMAN NF-kappaB inhibitor epsilon (NF-kappa-BIE) (I- |
| | kappa-B-epsilon) (IkappaBepsilon) (IKB-epsilon) (IKBE) |
| gi\|6226705 | alpha SNAP [Homo sapiens] |
| NM_005572 | Homo sapiens lamin A/C (LMNA). transcript variant 2 |
| NM_004418 | Homo sapiens dual specificity phosphatase 2 (DUSP2) |
| NM_016257 | Homo sapiens hippocalcin like 4 (HPCAL4) |
| gi\|1297097 | HLA-C alpha chain |
| NM_006360 | Homo sapiens PCI domain containing 1 (herpesvirus entry |
| | mediator) (PCID1) |
| NM_014593 | Homo sapiens CXXC finger 1 (PHD domain) (CXXC1). mRNA |
| NM_001010850 | Homo sapiens fusion (involved in t(12.16) in malignant liposarcoma) |
| | (FUS). transcript variant 2. mRNA |
| NM_002954 | Homo sapiens ribosomal protein S27a (RPS27A). mRNA |
| gi\|17386088 | ras effector-like protein |
| NM_002383 | Homo sapiens MYC-associated zinc finger protein (purine-binding |
| | transcription factor) (MAZ). mRNA |

1-4. (canceled)

5. A method for in-vitro diagnosis and/or stratifying the risk of Alzheimer's disease, in particular Alzheimer's dementia, in a patient comprising detecting at least one marker sequence selected from the group of SEQ 1-179 and/or SEQ 1a-179a or each encoding a peptide thereof, or a partial sequence or fragment thereof.

6. The method of claim 5, for identification of patients with increased risk and/or unfavorable prognosis of Alzheimer's disease, in particular Alzheimer's dementia, and symptomatic and/or asymptomatic patients.

7. The method of claim 5, wherein the marker sequences are fixed on a solid support, in particular a filter, a membrane, a magnetic bead, a silica wafer, glass, metal, ceramics, plastics, a chip, a target for mass spectrometry or a matrix.

8. A method for diagnosing Alzheimer's disease, in particular Alzheimer's dementia, wherein
at least one marker sequence selected from the group of SEQ 1-179 and/or SEQ 1a-179a or each encoding a peptide thereof, or a partial sequence or fragment thereof is/are fixed on a solid support,
contacting with a bodily fluid or tissue of a patient,
determining/detecting a binding event between the bodily fluid and the marker sequence(s).

9. An array, assay or diagnostic device for diagnosing Alzheimer's disease, in particular Alzheimer's dementia comprising at least one cDNA selected from the group of SEQ 1-179 and/or SEQ 1a-179a or each encoding a peptide thereof, or a partial sequence or fragment thereof is/are fixed on a solid support.

10. (canceled)
